(19) United States
(12) Patent Application Publication
(10) Pub. No.: US 2014/0083564 A1
(43) Pub. Date: Mar. 27, 2014

(54) INK-REFILLED CONVECTION DEVICE FOR INTRODUCING INK INTO AN INK CARTRIDGE

(71) Applicant: Yi-Tsung Yan, Taipei City (TW)

(72) Inventor: Yi-Tsung Yan, Taipei City (TW)

(21) Appl. No.: 14/093,019

(22) Filed: Nov. 28, 2013

Related U.S. Application Data
(63) Continuation of application No. 13/416,218, filed on Mar. 9, 2012.

(51) Int. Cl. B41J 2/175

(52) U.S. Cl. CPC B41J 2/17506
USPC 141/319

(57) ABSTRACT

A ink-refilled convection device for introducing ink into an ink cartridge is disclosed. The ink-refilled convection device comprises a convective refill unit, an ink container, and an opening hole. The convective refill unit has a base body at lower portion of the convective refill unit, a drain conduit disposed in the first cylindrical hole, a vent conduit disposed in the second cylindrical hole. The ink container has an inner cap disposed at opening of the ink container with a taper column detachably engaged with the taper cylindrical hole. Wherein said convective refill unit connected with the cap of the ink container, the convective refill unit of said vent conduit is passed through the opening hole with the first end of the vent conduit kept approaching to the bottom of the ink container and the second end of the vent conduit extended to exterior of the column body through the recess, between the column body and the second end of the drain conduit.

### CROSS-REFERENCE TO RELATED APPLICATION

This U.S. Non-provisional application for patent is a Continuation-In-Part (CIP) application of patent application Ser. No. 13/416,218 filed on Mar. 9, 2012. The entirety of the above-mentioned patent application is hereby incorporated by reference herein and made as a part of this specification.

### BACKGROUND OF THE INVENTION

1. Field of the Invention

The present invention relates to an ink cartridge refill device, and particularly to an ink cartridge refill device exploiting the phenomenon of convection to achieve automatically refill and predetermined ink level made.

2. Description of Related Art

Conventionally, refilling an ink cartridge requires a user to insert a single refilling needle in an inkbottle, insert the refill needle into an ink storage space of the ink cartridge, and squeeze the inkbottle by hand to refill the ink cartridge. Problems such as underfill or overfill may happen because refill amount varies with different squeezing force applied by the user and may cause ink leakage from the ink outlet of the ink cartridge or inkjet head. The aforementioned refill method is difficult to a majority of consumers.

As to ink cartridge manufacturers, in order to prevent used ink cartridges from being refilled with third-party ink and reused, they modify the ink storage medium (e.g. sponge) and the space design of ink storage chambers. They fill their ink cartridges with a proper amount of ink or to a proper ink level in the factory under low pressure. If the user tries to refill an empty ink cartridge in the traditional “syringe and pressurization” way, the ink cartridge will not absorb the incoming ink at proper speed and will leak a large amount of ink as a result of the modification in storage space and absorption speed of the ink storage sponge. Thus, refill of the ink cartridge cannot be completed and the ink cartridge cannot be reused.

Some ink cartridges in off-the-shelf printers are only used for functional tests. In order to prevent their being refilled and reused, manufacturers greatly reduce their chamber space for ink storage sponge and install sponges with low absorption speed so that ink refilled into the ink cartridge easily exceeds the volume of the chamber space, overflows into the chamber without sponge, and leaks out of the ink cartridge when the ink cartridge is on printing. Therefore, consumers cannot refill the ink cartridge with traditional refill means.

Among ink refill technologies, ink refill with natural convection is disclosed in several prior arts explained hereinafter:

Japanese Patent No. 3255517 discloses a prior art. FIG. 1 shows an ink cartridge with a large refill hole. An ink storage sponge is disposed inside the ink cartridge. A convection tube is disposed extending from the top of the inkbottle above the ink cartridge. One conduit of the convection tube is inserted in the ink storage sponge. Another conduit of the convection tube is disposed above the ink storage sponge with its other end inserted in the upper portion of the inkbottle. During ink refill, the conduit inserted in the inkbottle admits air, and the conduit inserted in the ink cartridge allows natural ink permeation to the ink storage sponge. Ink refill stops when the ink level reaches the end opening of the other conduit disposed above the ink storage sponge. Disclosure of this prior art is merely theoretical operation. In practice, ink leakage occurs even before the convection tube is inserted in the refill hole and occurs again upon its detachment.

Japanese Utility Model No. 3081128, which is corresponding to U.S. Pat. No. 6,364,473 and Taiwanese Utility Model No. M123456, discloses another prior art. The disclosed device has two slender needles of different lengths in contact with each other. They are disposed on a needle base with one of their ends level. Extending outside the needle base are two slender needles of different lengths. To refill ink, the refill needle is first inserted in the connector of the inkbottle. To refill an ink cartridge, the refill needle is inserted and fixed in the refill hole of the ink cartridge. The external portion of the longer needle is inserted in the bottom portion of the ink storage sponge, and the shorter needle of the refill needle is inserted in the ink cartridge at a predetermined level above the ink storage sponge.

The preceding prior art illustrates that convective refill with circulation between ink and air will occur once the inkbottle is pressed. However, experiments show that even if the diameters of the two slender needles and ink viscosity are taken into consideration, the theoretical outcome is not achieved after the refill needle is inserted in the sponge of the ink cartridge and the inkbottle is pressed. The ink refill amount from the inkbottle to the ink cartridge is merely equivalent to the ink flow caused by pressing the inkbottle. The causes are as follows:

The two slender needles of different lengths are disposed on a needle base with one of their two ends level. During refill, the inkbottle is inversed (i.e. upside-down arrangement) and the ink inside provides a hydrostatic pressure. Once air flows into the inkbottle, the ink inside will naturally flow downward and refill the ink cartridge by means of permeation. However, due to the hydrostatic pressure from the ink inside the inkbottle, the shorter needle disposed levelly on the needle base does not merely allow air. Therefore, the circulation between ink and air as is disclosed in the literature is not achieved and the refill amount cannot be controlled.

Similar to the abovementioned prior arts, U.S. Pat. No. 7,303,267 B2 discloses two conduits of different lengths are properly disposed on the plane of a container. The level ends of the two conduits are inserted in a column base body on the plate of the container. Similarly, the outcome of automatic downward ink flow and air inflow is not achieved. The prior art teaches that “If ink does not flow automatically (as is indicated by the generation of bubbles in the ink tank or the lowering of ink level in the ink tank),” a pressurization pump can be used to change the pressure in the ink container. The prior art further clearly teaches that “The ink does not flow automatically downwards because the weight of the ink keeps the air from going upwards to the ink tank and convection is obstructed.”

Fundamentally, the setup of the two conduits in this prior art is normal. However, it is obviously difficult to connect two cylindrical conduits tangent to each other to the surface of a transparent ink container. The disclosure of the literature may prove unfeasible.

Further, U.S. Pat. No. 7,325,909 B2, which is granted to the same inventor of U.S. Pat. No. 7,303,267 B2, uses two concentric conduits with different diameters. One end of the outer conduit tapers and connects with the inner conduit so that the two conduits are welded together to form an independent convection tube. The outer conduit of the convection tube has a vent and forms a vent conduit. The longer inner conduit of the convection tube can be inserted in the ink storage sponge of an ink cartridge for ink to drop automatically. One end of the conduit is level with and connects to a cylindrical hole of an ink container. Moreover, a seal member is reinforced to facilitate transportation and storage. However, it was commercialized in 2006 for only a short period of time and then disappeared.

Experiments show the following result. The disclosed concentric convection tube is disposed at the connection end in the ink container. The two conduits are level with each other. The position where ink starts flowing downward and the position where air stops flowing in are the same. Hydrostatic pressure in the container causing ink to flow automatically downwards at the same time impedes air from flowing upwards. Therefore, it fails to automatically refill an ink cartridge and can not refill the ink cartridge to a predetermined level.

In U.S. Pat. No. 8,251,468 B2; U.S. Pat. No. 8,465,136 B2 and US Published Patent Application No. US 2010/0134570 A1, is same Inventor Yuen, shown the drain conduit and vent conduit structure and technology; as shown in U.S. Pat. No. 8,465,136 B2, the ink needle 222 connects the ink chamber 201 and the inside of the ink cartridge. The upper end of the ventilated needle 223 extends into the ventilated post 203, and the lower end of the ventilated needle 223 extends into the ink cartridge 30. The ventilated needle 223 connects the ventilated post 203 and the inside of the ink cartridge 30. The ink in the ink chamber 201 is delivered to the ink cartridge 30 through the ink needle 222. The air in the ink cartridge 30 is exhausted out through the ink needle 222. The air in the ink cartridge is exhausted out through the ventilated needle 223.

As shown in U.S. Pat. No. 8,251,468 B2, in the depicted embodiment the bottom wall of the ink compartment included an aperture 80 that is in fluid communication with the vent tube 30. The aperture 80 is configured to receive a sealing member 82 that seals the aperture 80 to prevent ink from flowing out of the ink compartment 20 through the vent tube 30. In the depicted embodiment, the sealing member 82 is configured to receive a vent post that extends through the sealing member 82 into the vent tube 30 during the ink refilling process. The vent post 84 allows air to flow into the ink compartment 20 as the ink drains from the compartment during the refilling of an ink cartridge. It should be appreciated that many alternative embodiment are possible.

As shown in US Published Patent Application No. 2010/0134570 A1, an alternative configuration for attachment of a coaxial arrangement of the drain and vent conduits 214, 216 to an upper housing 212 is shown and described. The attachment arrangement includes an attachment member 201, an o-ring 202, and an attachment member recess 203 and an o-ring recess 204 formed in a bottom wall 224 of an upper housing member. The coaxially arranged drain and vent conduits 214, 216 extend through a vent and drain conduits 214, 216 extend through a vent and drain opening 236 formed an alignment with the recesses 203, 204 where the o-ring and attachment member 201 are secured to an end of the vent conduit 216. The O-ring provide a fluid seal between an exterior of the vent conduit 216 and an internal ink tank 222 of the housing member.

In US Published Patent Application No. 2010/0134570 A1, shown in the upper end of the ventilated needle extends into the ventilated post, and the lower end of the ventilated needle extends into the ink cartridge.

Among those prior art regarding to the ink refill device, the refill unit are not equipped with vent conduit made of stainless steel, not even discloses an end of the vent conduit kept approaching to the bottom of the ink container. Therefore the ink cannot be smoothly and automatically charged the ink cartridge if the ink container is turned upside-down. How to achieve smoothly and automatically refill and charge the ink into the container with predetermined level are critical issue needs to be settled.

### SUMMARY OF THE INVENTION

The primary object of the present invention is to have the ink refilled convection device been smoothly flowed the ink outward automatically, without choked by the air pressure. Then the charging action of the ink-refilled convection device will be automatically stopped through the convection blocked by the predetermined level of charged ink is reached.

To achieve the above purposes, an ink-refilled convection device for introducing ink into an ink cartridge is disclosed. The ink-refilled convection device comprises a convective refill unit, an ink container, and an opening hole. The convective refill unit has a column body at upper portion of the convective refill unit with a recess disposed at top of the column body to communicate interior of the column body with exterior of the column body, a base body at lower portion of the convective refill unit, a first and a second cylindrical holes passing through the convective refill unit, a drain conduit disposed in the first cylindrical hole, a vent conduit disposed in the second cylindrical hole, and a taper cylindrical hole defined in the base body and communicated with the first and the second cylindrical holes. The ink container has an inner cap disposed at opening of the ink container with a taper column detachably engaged with the taper cylindrical hole. The opening hole is disposed at lower portion of interior of the taper column. Wherein the vent conduit is passed through the opening hole with a first end of the vent conduit kept approximately approaching to bottom of the ink container and a second end of the vent conduit extended to exterior of the column body through the recess, and a first end of the drain conduit is located at the taper cylindrical hole and kept a distance away from the taper column when the taper column is inserted into the taper cylindrical hole.

According to one embodiment of the ink-refilled convection device, wherein the drain conduit has a second end extended outward and went beyond the second end of the vent conduit.

As a result, the ink refilled convection device of the present invention may smoothly flow the ink outward, without choked by the air pressure outside the conduit, hence no need to squeeze the ink container while the ink container is inversed and engaged with the ink cartridge (i.e. charging action for the cartridge). In this manner, convection and air pressure effect may be exploited to achieve automatically refill, until a predetermined ink level is reached. Then the charging action of the ink-refilled convection device will be automatically stopped through the convection blocked.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1 is an isometric view of the invention and shows a convective refill unit inserted in an ink container and an ink cartridge.

FIG. 2 is an isometric view of the invention and shows the convective refill unit inserted upside-down in the ink cartridge.

FIG. 3 is a disassembled view of the invention and shows the structure of the ink container.

FIG. 4 is a disassembled view of the invention and shows the convective refill unit and the ink container in a separate condition.

FIG. 5 is a sectional view of the invention and shows the insertion and connection of the ink container and the convective refill unit.

FIG. 6 is a sectional view of the invention and shows a move of inserting the ink container to the ink cartridge.

FIG. 7 is a sectional view of the invention and shows a second move of inserting the ink container to the ink cartridge.

FIG. 8 is a sectional view of the invention and shows a third move of inserting the ink container to the ink cartridge.

FIG. 9 is a sectional view of the invention and shows a move of convectively refilling the ink cartridge.

FIG. 10 is a sectional view of the invention and shows a second move of convectively refilling the ink cartridge.

FIG. 11 is a sectional view of the invention and shows a third move of convectively refilling the ink cartridge.

FIG. 12 is a sectional view of the invention and shows the ink cartridge after completion of convective refill.

FIG. 13 is a sectional view of the invention and shows a drawing of the second embodiment of the ink cartridge.

FIG. 14 is a sectional view of the invention and shows refilling of a third embodiment of the ink cartridge.

FIG. 15 is a sectional view of the invention and shows refilling of a third embodiment of the ink cartridge.

FIG. 16 is a sectional view of the invention and shows a drawing of the fourth embodiment of the ink cartridge.

FIG. 17 is a sectional view of the invention and shows a drawing of the fifth embodiment of the ink cartridge.

FIG. 18 is a sectional view of the invention and shows a drawing of the sixth embodiment of the ink cartridge.

FIG. 19 is a sectional view of the invention and shows a drawing of the seventh embodiment of the ink cartridge.

FIG. 20 is a sectional view of the invention and shows a drawing of the eighth embodiment of the ink cartridge.

FIG. 21 is an isometric view of the invention and shows the structure of the convective refill unit.

FIG. 22 is a sectional view of the invention and shows an enlarged top view of the convective refill unit.

FIG. 23˜24 are sectional views of the invention which demonstrate the flowing of ink inside the drain conduit and vent conduit.

### DETAILED DESCRIPTION OF THE PREFERRED EMBODIMENTS

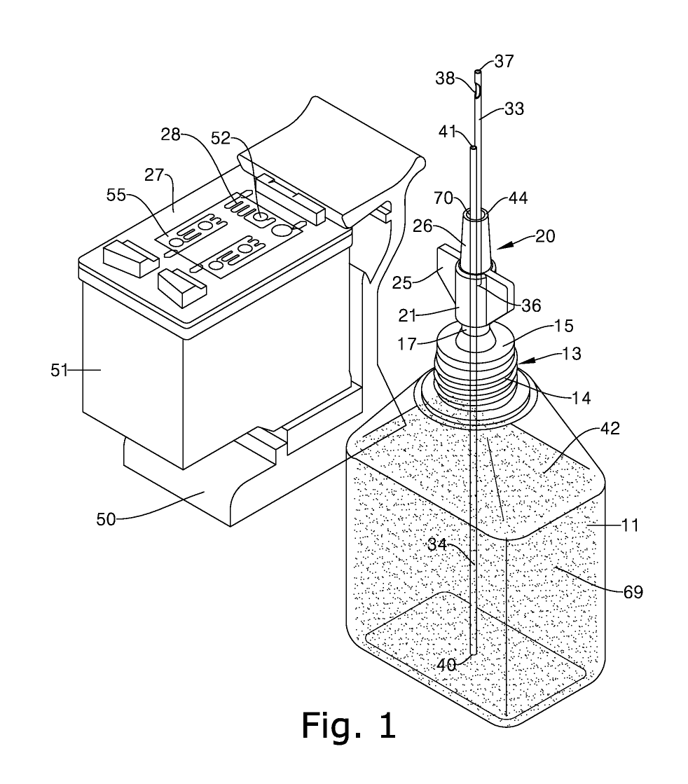

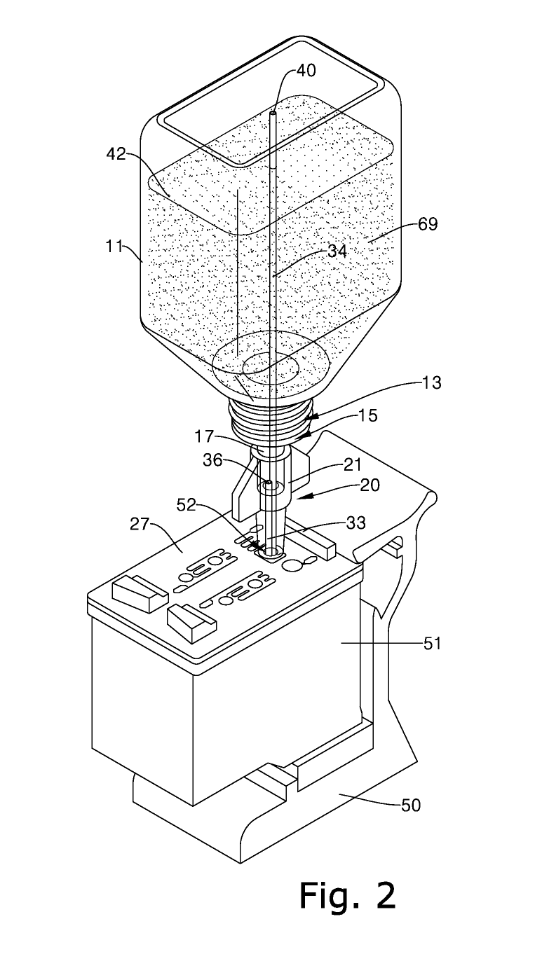

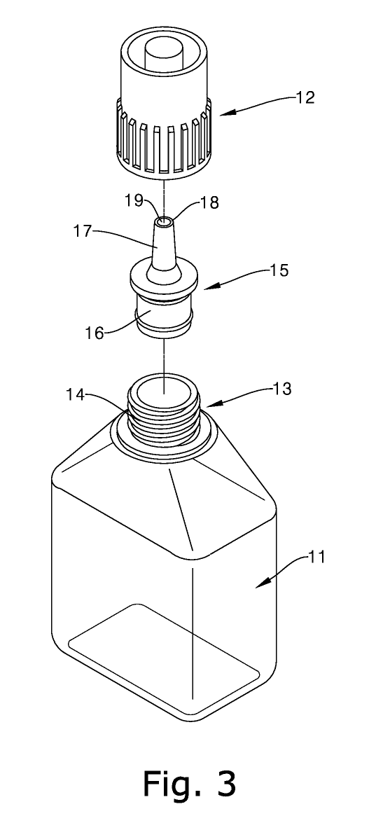

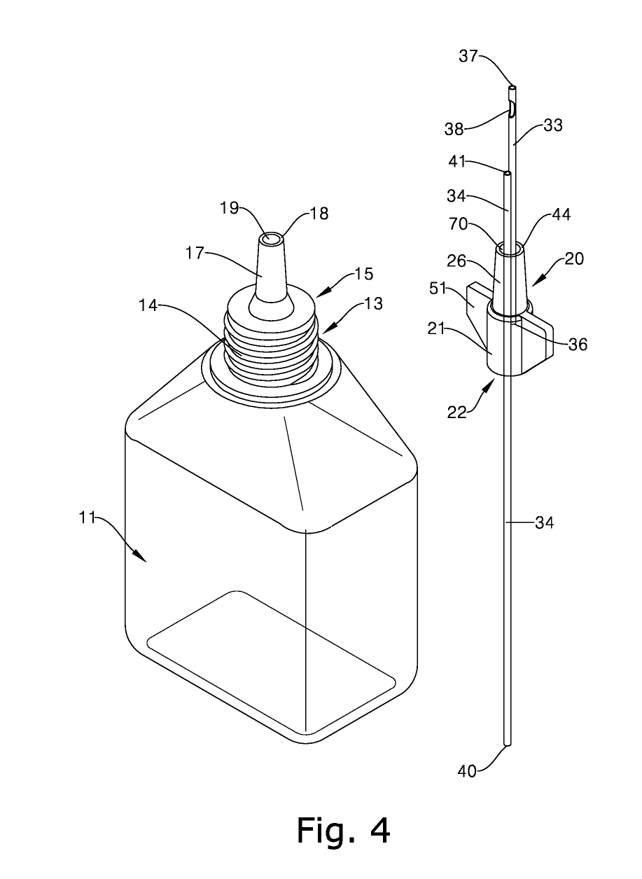

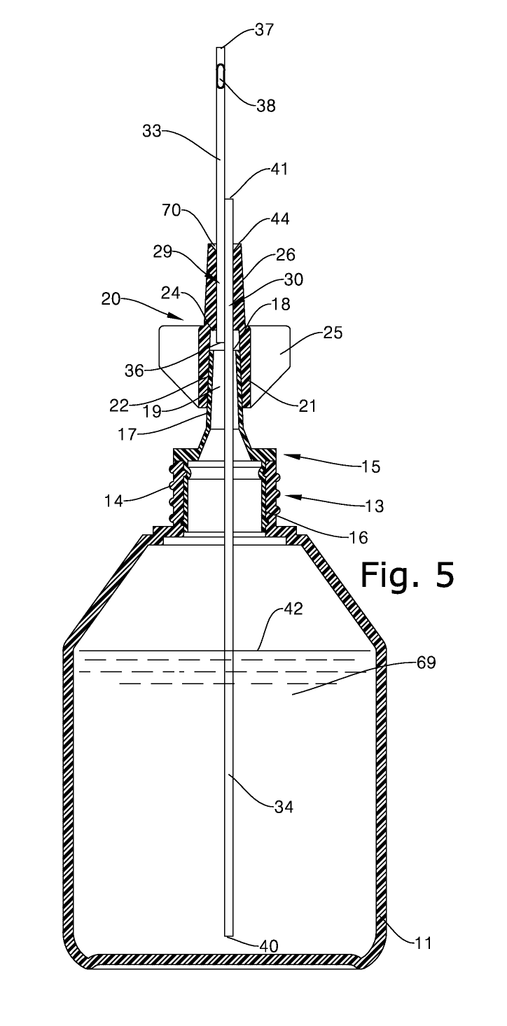

The invention relates to an ink refilling convection device for ink refill. As shown in FIG. 1 to FIG. 5, the ink refilling convection device comprises a convective refill unit 20, an inner cap 15 and an ink container 11. A to-be-refilled ink cartridge 51 is first fixed on a protective holder 50. Except for FIGS. 1 and 2, the holder 50 for fixing the cartridge is not shown in the following embodiments. Shown in FIG. 3 and FIG. 4, the inner cap 15 has a taper column 17 disposed at upper portion; the convective refill unit 20 has a taper cylindrical hole 22 faced downward. Therefore the taper column 17 may be inserted into the taper cylindrical hole 22, so as to tightly engage with the convective refill unit 20. Further shown in FIG. 5, two conduits 33, 34 with different lengths pass through the convective refill unit 20. More descriptively, the convective refill unit 20 further has a column body 26 at upper portion, a base body 21 at lower portion, and two cylindrical holes 29, 30 vertically passed through the convective refill unit 20. In the preferable embodiment, the first cylindrical hole 29 is parallel to and contacted to the second cylindrical hole 30. In this manner, the drain conduit 33 can be vertically disposed in the first cylindrical hole 29, and the vent conduit 34 can be vertically disposed in the second cylindrical hole 30. The drain conduit 33 has a first end 36 at lower portion and a second end 37 at upper portion; the vent conduit 34 also has a first end 40 at lower portion and a second end 41 at upper portion. After the conduits 33, 34 are assembled with the convective refill unit 20, the second end 37 and the second end 41 are extended above the column body 26, and the first end 36 and the first end 40 are extended beneath the column body 26; in the embodiment as shown in FIG. 5, the first end 36 of the drain conduit 33 slightly goes downward beyond the column body 26 when the drain conduit 33 is inserted in the first cylindrical hole 29. The first end 40 of the vent conduit 34 further goes downward beyond the column body 26 when the vent conduit 34 is inserted in the second cylindrical hole 30; i.e. the first end 40 of the vent conduit 34 is kept approaching to the bottom of the ink container 11. Besides, the top of the vent conduit 34 is between the top of the column body 26 and the top of the drain conduit 33. In the preferable embodiment, the drain conduit 33 and the vent conduit 34 are movably adjusted against the column body 26. Moreover, the convective refill unit 20 further has the taper cylindrical hole 22 defined in the base body 21 and communicated with the first and the second cylindrical holes 29, 30. As for the ink container 11, the inner cap 15 has an opening hole 19 vertically passed through the inner cap 15, and a taper column 17 detachably engaged with the taper cylindrical hole 22. When the taper column 17 is inserted into the taper cylindrical hole 22 as shown in FIG. 4-5, the vent conduit 34 is passed through the opening hole 19 and the first end 36 of the drain conduit 33 is kept a distance away from the taper column 17; meanwhile, the top of the taper column 17 is kept a distance beneath the column body 26. In this manner, ink may be smoothly flowed from the opening hole 19 to the first end 36, so as to easily enter the drain conduit 33

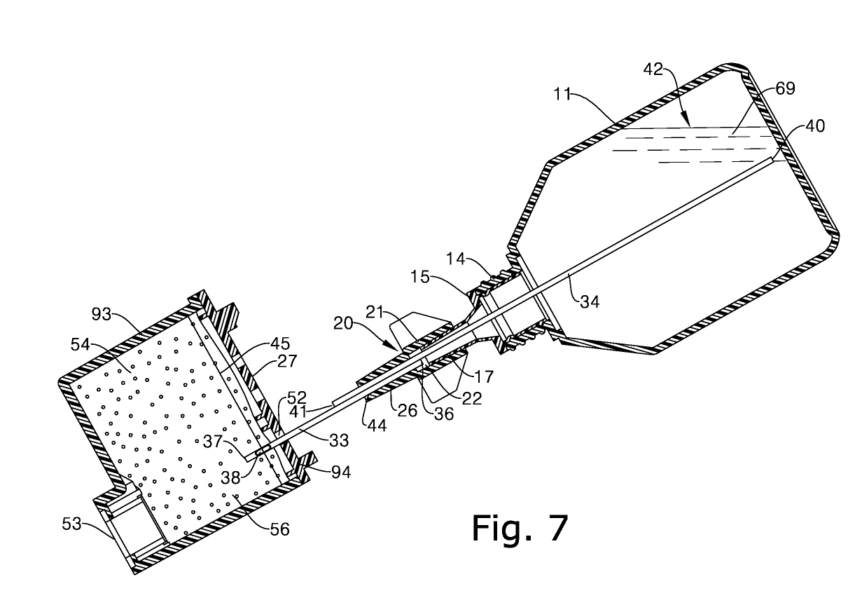

Also as shown is FIGS. 1 and 2, after a sticker 55 on a plane 27 of the ink cartridge 51 is removed, an engraved pattern 28 for balancing and a refill hole 52 are found to be disposed on the plane 27 of the ink cartridge 51. Please also refer to FIGS. 4 to 8. The convective refill unit 20 above the ink container 11 is inserted in and connected to the refill hole 52 of the ink cartridge 51, the ink container 11 and the convective refill unit 20 are inversed (i.e. upside-down arrangement), and an first end 40 of the vent conduit 34 is above a level 42. After pressing the ink container 11, ink flows downward and permeates an ink storage sponge 54 through a long notch 38 on a side of the drain conduit 33 inserted in a chamber 56 of the ink cartridge 51. At the same time, a circulation system between the ink container 11 and the convective refill unit 20 is activated to automatically refill a space of the ink storage sponge 54 with ink until ink level reaches a level 45 predetermined by the vent conduit 34.

Please refer to FIG. 3. The ink container 11 is an inkbottle. The bottle body of the ink container 11 can be filled with a proper amount of ink (ink is not shown in the figure). In an upper portion of the inkbottle, a thread 14 is disposed on an exterior of a bottle opening 13. The inner cap 15 disposed at upper opening of the ink container 11 may be fastened to the ink container 11 by thread 14. A taper column 17 is disposed at upper portion of the inner cap 15; an outside cap 12 is threaded connected with the thread 14 of the bottle opening 13 for increasing mechanical strength, and the ink container 11 therefore may be ready to be commercially transported.

The ink container of the invention comprises:

A container made up of extruded assemblies such as bottle, cap, etc. includes at least a bottle body and a cap. A taper column is disposed at an upper portion of the cap of the container for insertion and connection of the convective refill unit 20.

Plastic injection molded assemblies are ultrasonic welded to form a container. A taper column is disposed on the container for insertion and connection of the convective refill unit 20.

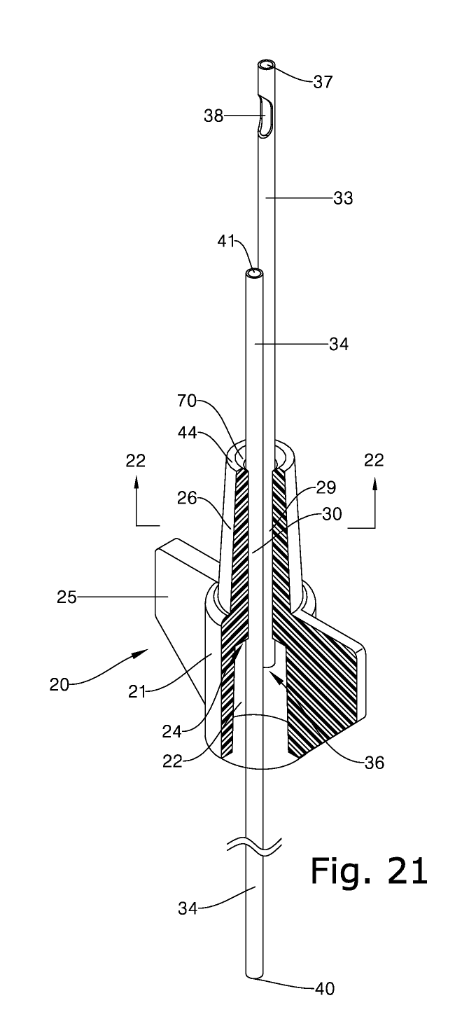

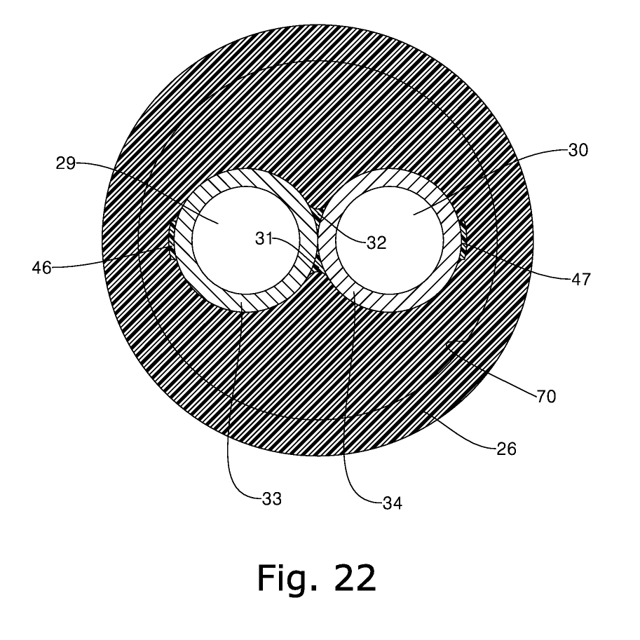

Please refer to FIGS. 1, 4, 5 and 21. The convective refill unit 20 may be inserted on the taper column 17 of the ink container 11. The convective refill unit 20 includes a drain conduit 33, a vent conduit 34, and base body 21; two conduits 33, 34 having different lengths are coupled together and inserted into two parallel cylindrical holes 29, 30. A column body 26 is disposed at an upper portion of the base body 21. The conduits 33, 34 with different lengths; the drain conduit 33 and the vent conduit 34 are inserted in a center of the column body 26. A taper cylindrical hole 22 is disposed at a lower portion of the column body 26 and a symmetric wing 25 is disposed outside the taper cylindrical hole 22. When the taper column 17 of the ink container 11 is inserted into the convective refill unit 20, the taper cylindrical hole 22 and the taper column 17 may be tightly fastened and sealed. The symmetric wing 25 outside can be rotated to effortlessly detach the convective refill unit 20 from the taper column 17 of the ink container 11. Besides, the column body 26 has a recess 70 (shown in FIG. 21) passed from the top of the column body 26 toward the taper cylindrical hole 22, such that the recess 70 communicates inside of the column body 26 (i.e. the taper cylindrical hole 22) toward exterior of the column body 26. As shown in FIG. 21 of the embodiment, the recess 70 goes vertically and penetrates through the column body 26, so that the conduit 33, 34 may be disposed along with the recess 70.

A taper cylindrical hole 22 is disposed in the base body 21 and the column body 26 is disposed on the taper cylindrical hole 22. In the center of the column body 26, there are two parallel and tangent cylindrical holes 29, 30. A recess 70 is disposed at an upper end of the column body 26. The first cylindrical hole 29 and the second cylindrical hole 30 are used for insertion of the drain conduit 33 and the vent conduit 34 respectively. After adjusting insertion length, an adhesive is used for permeation, curing and integration. Before integration of the assemblies of the convective refill unit 20, the first cylindrical hole 29 and the second cylindrical hole 30 for insertion of the drain conduit 33 and the vent conduit 34 are molded from a column body of a mold which is fabricated with electrical discharge machining and which has a surface with irregular imprints. The first cylindrical hole 29 and the second cylindrical hole 30 on the column body 26 of the formed base body 21 have irregular surface imprints.

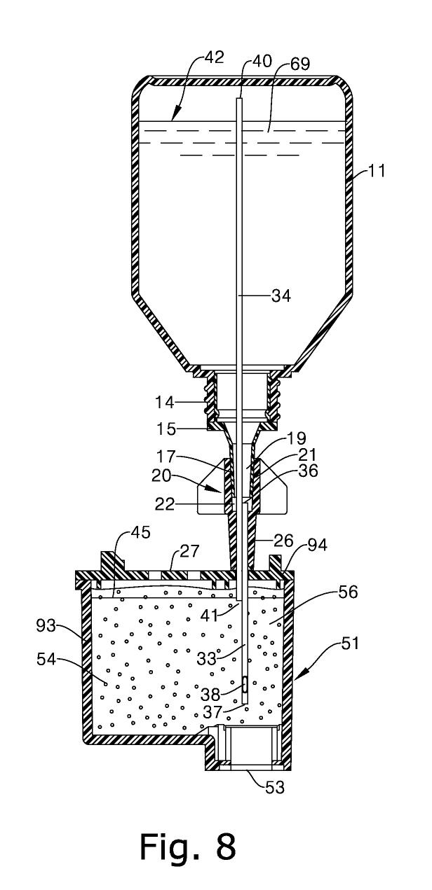

Furthermore, the drain conduit 33 and the vent conduit 34 made of stainless steel tubes feature capillary tube structure and conform to the grade 19G of the hypodermic needles gauge with an outer diameter of 1.067 mm and an inner diameter of 0.686 mm. Two conduits 33, 34 have smooth surfaces; the drain conduit 33 and the vent conduit 34 are inserted in the first cylindrical hole 29 and the second cylindrical hole 30 respectively, to have strong contact forces. The insertion length of each of the conduits can be adjusted respectively according to applied force. The drain conduit 33 and vent conduit 34 are coupled together and inserted into two parallel cylindrical holes 29, 30 to integrate with the column body 26. The drain conduit 33 having first end 36 and second end 37, with the second end 37 being exposed outside of the column body 26. Preferably, the second end 37 is as longer as possible to be able to reach the bottom of the ink cartridge 51 (shown in FIG. 2) when the action of re-fill is made. Namely, the length of the drain conduit 33 is corresponded to and determined by the ink cartridge 51. In contrary, the bottom of the drain conduit 33, i.e. first end 36, is located in the taper cylindrical hole 22, with slightly downward extending. Preferably, the first end 36 is not downward reached the top of the taper column 17 (i.e. the taper column end 18); namely, the first end 36 is kept a distance away from the taper column 17 (shown in FIG. 5). In this manner, the ink flowing inside the taper cylindrical hole 22 may have enough space, such that the capillarity effect around the first end 36 is not happened and therefore the choke is prevented. Additionally, that may also have advantage of no interference happened when the convective refill unit 20 is assembled/engaged with the taper column 17 (i.e. the taper column 17 is inserted into the taper cylindrical hole 22). The first end 36 of the drain conduit 33 is inserted in the first cylindrical hole 29 of the column body 26, to passes through an inner annulus 24; therefore the first end 36 has a short distance away from the inner annulus 24. The vent conduit 34 is also inserted in the second cylindrical hole 30 of the column body 26. The vent conduit 34 has the first end 40 and second end 41; the top of vent conduit 34, i.e. the second end 41, is extended outward and gone beyond the top of the column body 26. In contrary, the bottom of the vent conduit 34, i.e. the first end 40, is preferably as longer as possible to reach the bottom of the ink container 11 (shown in FIG. 1) when the convective refill unit 20 is engaged with the ink container 11. Besides, the drain conduit 33 also has the second end 37 extended outward and further went beyond the second end 41 of the vent conduit 34; namely the location of the second end 41 of the vent conduit 34 is between top of the column body 26 and the second end 37 of the drain conduit 33. In this manner, the length of a second end 41 with respect to the ink refill level of every ink cartridge 51 can be regulated according to the length of the drain conduit 33 and the insertion depth in the ink cartridge. The vent conduit 34 goes through the second cylindrical hole 30 of the column body 26, and its extension length to an outer end of the taper cylindrical hole 22 is according to a height of the ink container 11. The first end 40 of the vent conduit 34 is as close to the bottom of the ink container as possible, so as to keep at a short distance from the bottom. When ink refilled, the convective refill unit 20 and the ink container 11 is inversed (i.e. upside-down arrangement, shown in FIG. 8˜20) and is inserted in the refill hole 52 of the ink cartridge. And the first end 40 of the vent conduit 34 is above a level 42 of ink 69. By the way, the second end 37 has a long notch 38 on a needle surface which may improve the ink flowing out from the drain conduit 33.

Please refer to FIGS. 5. 21 and 22. The recess 70 is inside the column body 26. The first cylindrical hole 29 and the second cylindrical hole 30 are disposed at the center of the column body 26. Before the drain conduit 33 and the vent conduit 34 are inserted in the cylindrical holes 29 and 30, reserved symmetric gaps 31 and 32 are disposed on and under the location where the first cylindrical hole 29 is tangent to the second cylindrical hole 30. Gaps 46 and 47 are disposed at two lateral sides of the cylindrical holes 29 and 30. The drain conduit 33 is inserted in the first cylindrical hole 29, an end of the drain conduit 33 goes through the inner annuls 24, and an end opening 36 is at a short distance away from the inner annulus 24. Acrylic resin with high permeability, e.g. cyanoacrylate or UV curing adhesive, is used as an adhesive for adhering. A predetermined amount of acrylic resin drops from the recess 70 on the column body 26, goes quickly down from where the two cylindrical holes 29 and 30 are tangent to each other and from the symmetric gaps 31 and 32 between the two conduits 33 and 34, flows toward the gaps 46 and 47, and completely fills the microgaps among the cylindrical holes 29, 30 and the conduits 33, 34. When using cyanoacrylate, solvent in the resin will vaporize shortly, and hydroxyl ions formed on a surface of an object or from moisture will provide fast anionic polymerization for cyanoacrylate monomer. Long and strong chains will be formed and adhere the two conduits 33 and 34 to the column body 26. When using UV curing adhesive, a point light source or a surface light source of a UV curing device is used to perform curing of the UV curing adhesive and to complete adhering. Because the end opening 36 of the drain conduit 33 goes through the first cylindrical hole 29 and is at a short distance from the inner annuls 24, the adhesive will not flow to the end opening 36 of the drain conduit 33 during permeation of the adhesive and block the end opening.

As shown in FIGS. 4 and 5, before insertion and connection for the convective refill unit 20 and the taper column 17, a taper body shaped structure can be accommodated as the taper column 17 for easy insertion and tight connection. An opening hole 19 at an interior of a taper column end 18 which has a diameter slightly larger than the sum of diameters of the drain conduit 33 and the vent conduit 34 can be used. In this manner, no mutual contact or interference is occurred if the convective refill unit 20 is inserted in the central opening hole 19 of the taper column 17, so that the ink container 11 is assembled.

The taper cylindrical hole 22 of the convective refill unit 20 is designed according to the taper column 17 on the ink container 11. When the taper column 17 is inserted in and connected to the convective refill unit 20 as an integration, the end opening 36 of the drain conduit 33 extends to a space of the taper cylindrical hole 22 and is at a short distance from the end opening 18 of the taper column 17. Further, an inner diameter of the opening hole 19 of the taper column 17 is larger than the sum of diameters of the two conduits 33 and 34 so that there will be no obstruction in ink refill.

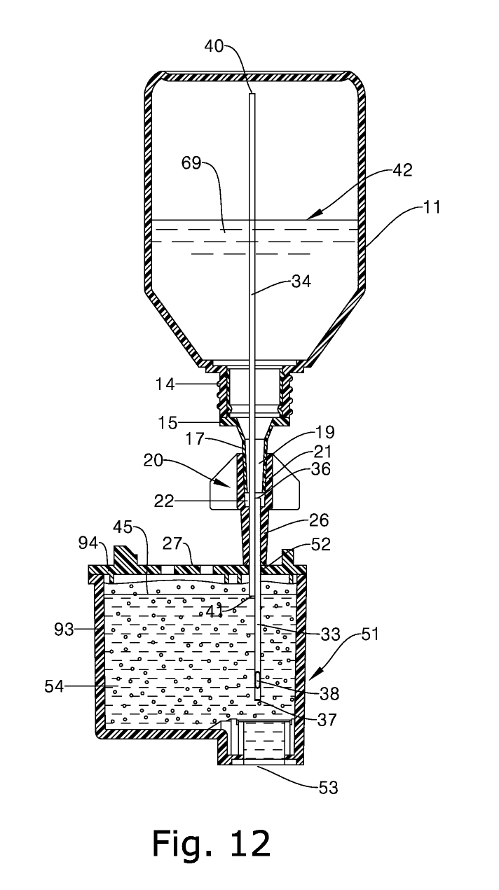

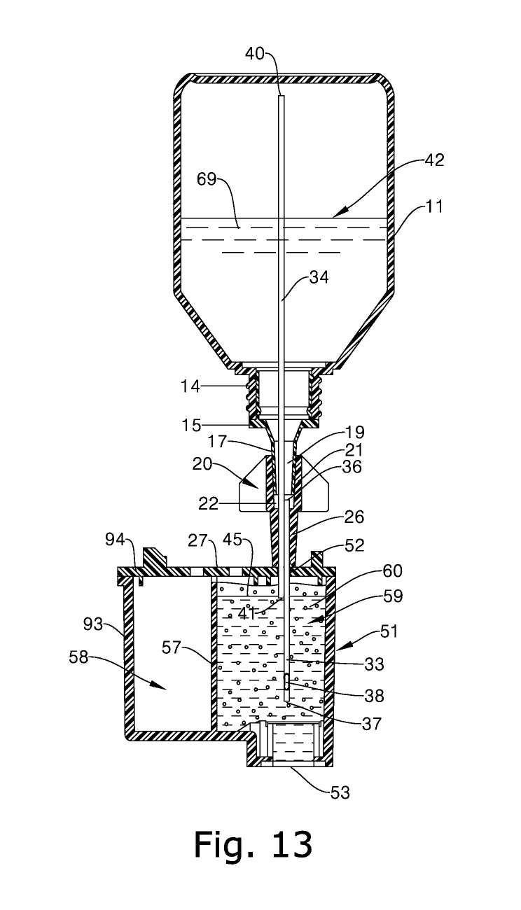

FIGS. 12 to 14 show three different types of ink cartridge 51. As to the ink cartridge 51 in FIG. 12, an inkjet head 53 is disposed on a lower portion of the housing 93. A chamber 56 inside the housing 93 provides a space for an ink storage sponge 54. An upper cover 94 is disposed at an open end of the chamber 56, and connection between the upper cover 94 and the housing 93 is ultrasonic welded as an integration. A larger amount of ink can be filled in the ink storage sponge 54 of the ink cartridge 51. As shown in FIG. 13, an inner space of the housing 93 of the ink cartridge 51 is divided into two chambers 58 and 59 with a partition 57. A smaller ink storage sponge 60 is put only in a space of the chamber 59. If the partition 57 is shifted rightward, the space of the chamber 59 becomes smaller and so does the ink storage sponge 60 and the amount of ink stored within.

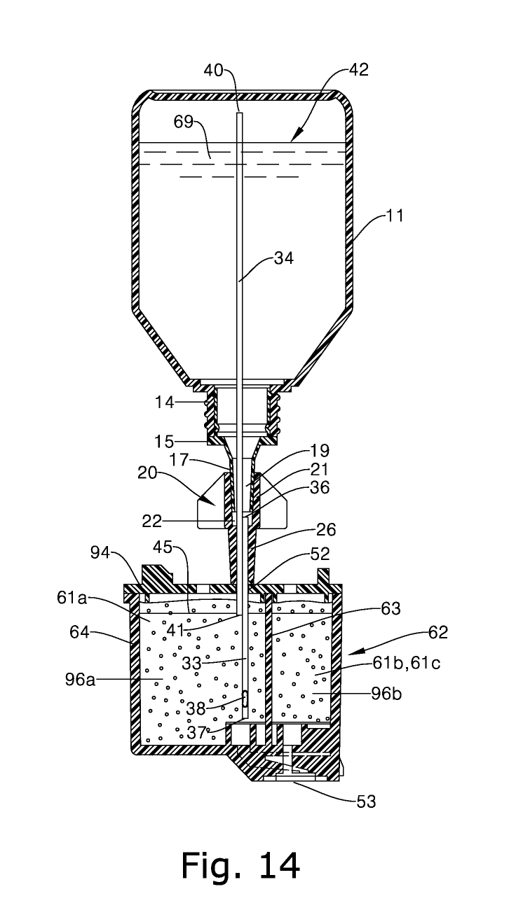

As shown in FIG. 14, a housing 64 of an ink cartridge 62 is divided into several chambers 61a, 61b, (61c) with a partition 63. An ink storage sponge is put in an inner space of each chamber respectively. A channel is disposed at a lower compartment of each chamber 61 to provide ink of different colors to meet printing requirements of the inkjet head 53.

As shown in FIGS. 1 to 5, for ink refill of different types of ink cartridges 51 containing the open the cap 12 on the ink container 11, and the taper column 17 on the ink container 11 is found, so that the taper column 17 may be inserted in and connected to the taper cylindrical hole 22 of the convective refill unit 20. The vent conduit 34 on the convective refill unit 20 is inserted in a lower portion of the inkbottle and keeps at a short distance from a bottom plane when the assemblies are inserted and connected. The taper cylindrical hole 22 of the convective refill unit 20 is tightly connected with the taper column 17. The end opening 18 of the taper column 17 is at a short distance away from the end opening 36 of the end drain conduit 33. The length of the drain conduit 33 is larger than the length of the vent conduit 34. Furthermore, a length of the vent conduit 34 disposed at an outer end of the base body 21 can be utilized to set a level for ink refill.

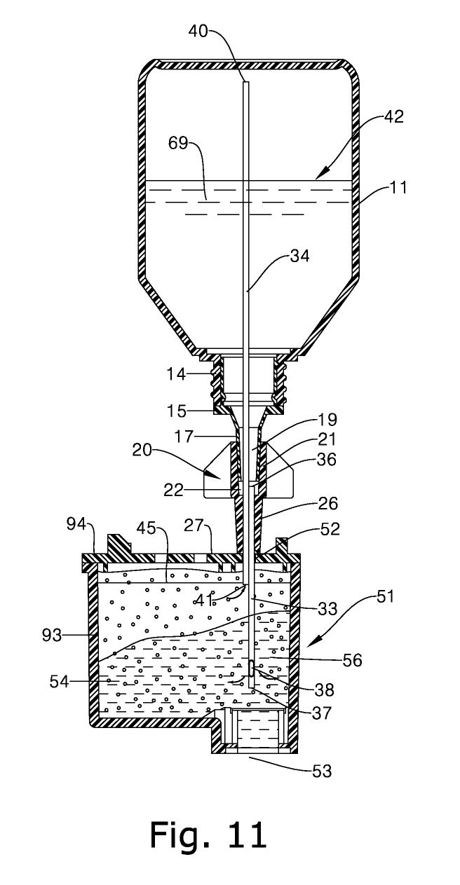

As shown in FIGS. 5 to 12, during ink refill of the ink cartridge 51, the length of the drain conduit 33 of the convective refill unit 20 inserted in the ink container 11 is designed according to a height of the inner chamber 56 of the ink cartridge 51. When the drain conduit 33 is inserted in a space of the chamber 56, an end opening 37 of the drain conduit 33 is close to and at a short distance from a bottom plane. The vent conduit 34 in contact to a side of the drain conduit 33 is of a proper length and the end opening 41 of the vent conduit 34 is inserted in the ink storage sponge 54 at a shallow depth. The depth is used to stop ink refill for the ink cartridge 51 when ink level reaches a predetermined level 45 defined by the end opening 41 of the vent conduit 34.

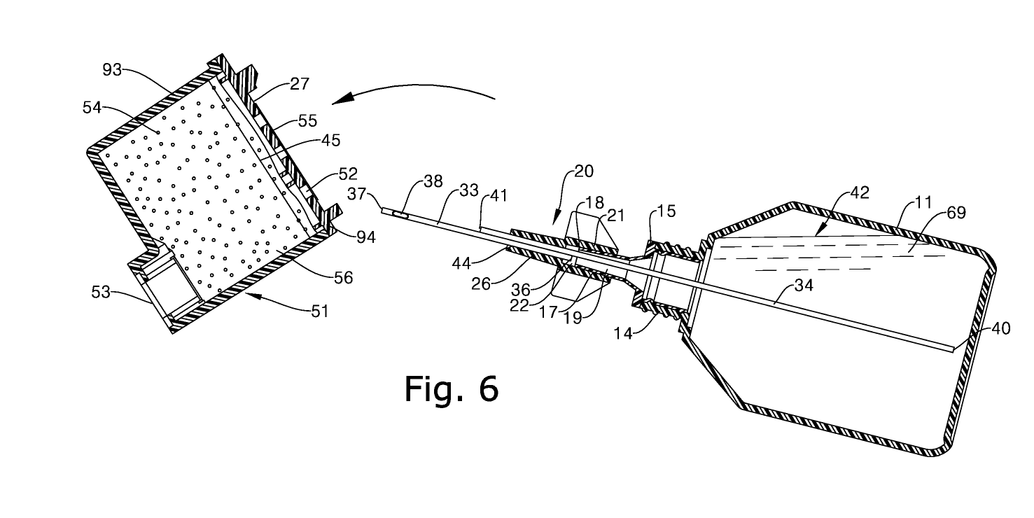

As shown in FIGS. 6 to 8, during ink refill of ink container 11, the convective refill unit 20 inserted on the ink container 11 is moved toward and inserted in the refill hole 52 of the ink cartridge 51. A ring surface 44 of the column body 26 of the convective refill unit 20 is in contact with a plane 27 outside the refill hole 52 of the ink cartridge 51. Finally, the ink container 11 and the convective refill unit 20 are inserted upside-down above the refill hole 52 of the ink cartridge 51. The first end 40 of the vent conduit 34 is inserted to a bottom portion of the ink container 11 and is above the level 42 of the ink container 11. The drain conduit 33 disposed at the outer end of the base body 21 is inserted in a deep depth of a lower portion of the ink storage sponge 54 of the ink cartridge 51. The end opening 41 of the vent conduit 34 pre-defining an ink refill level is inserted in a higher position of the ink storage sponge 54 to form a predetermined level of ink refill height.

If the inkbottle contains dye ink, the viscosity of the ink should be about 1.8-2.3 Pas and the surface tension of the ink should be about 29-30 N/m. If it contains pigment ink, the viscosity of the ink should be about 1.8-2.3 Pas and the surface tension of the ink should be about 31-33 N/m.

As shown in FIG. 8, during connection, insertion and refill of the ink cartridge 51, the ink in the vent conduit 34 will flow according to level change. Finally, when the ink container 11 is turned upside-down and the convective refill unit 20 disposed on the ink container 11 is inserted in the space of the ink storage sponge 54 inside the ink cartridge, the ink inside the ink container 11 will not be activated to flow downward if the ink container 11 is not pressed. This is due to equilibrium between the characteristics (surface tension and viscosity) of the ink and the vent conduit 34. On the other hand, if pressure inside the ink container 11 is pressed when the ink container 11 is inserted upside-down in the space of the ink storage sponge 54 inside the ink cartridge 51, equilibrium of the ink inside the vent conduit 34 will be affected. This may activate the circulation system between the ink container 11 and the convective refill unit 20, and the circulation system will start refilling once the upside-down insertion of the refill device is completed.

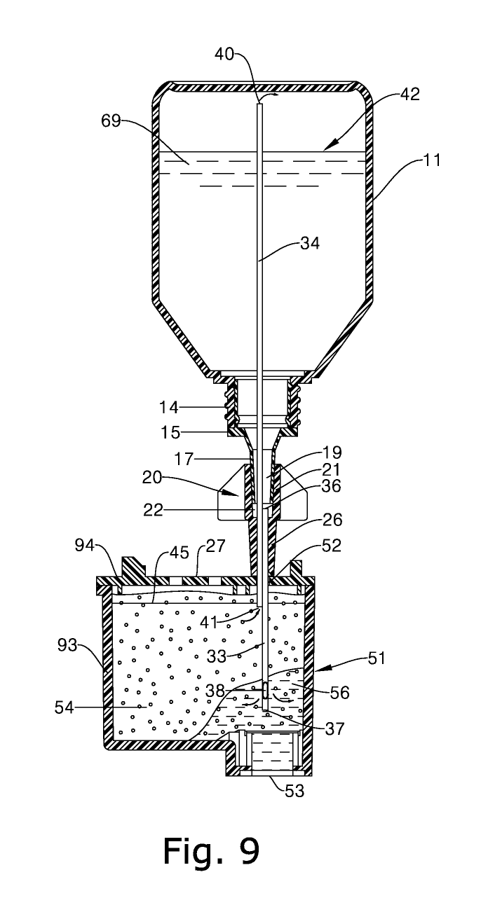

As shown in FIG. 9, slightly squeezing the bottle body of the ink container 11 will alter the pressure inside the ink container 11, and the ink in the ink container 11 will flow toward the two conduits 33 and 34. The moment the squeezing pressure vanishes, the position where the air above ink level 42 occupies is the best position for pressure recovery and displacement. Furthermore, the first end 40 of the vent conduit 34 of the convective refill unit 20 extends above the level 42. A negative pressure is quickly conducted by air and discharges the ink inside the vent conduit 34 outside the first end 40 of the ink container 11. At this moment, the circulation system between the ink container 11 and the convective refill unit 20 is activated. The ink 69 inside the ink container 11 is introduced through the slender drain conduit 33 into the space of the chamber 56 of the ink cartridge. From the end opening 37 of the drain conduit 33 and the long notch 38, the ink directly permeates the ink storage sponge 54 under gravity.

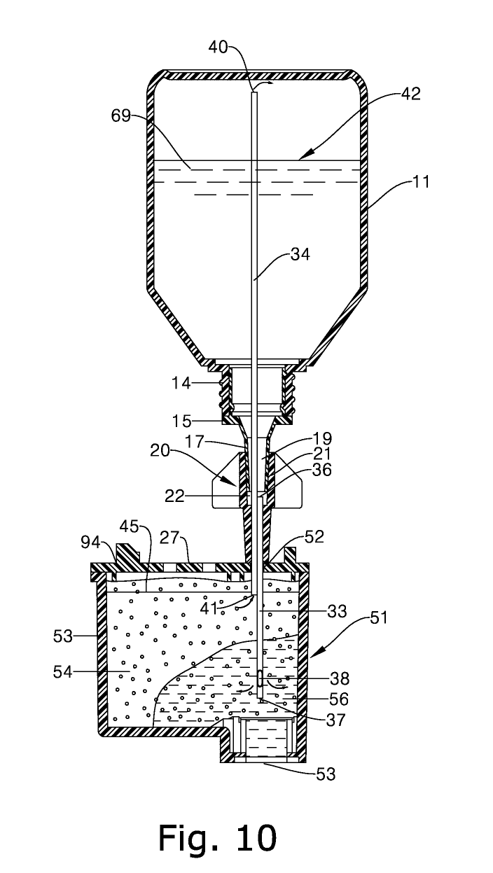

As shown in FIGS. 10 to 12, in the activated circulation system, the end opening 41 of the vent conduit 34 extends to an inner space of the ink cartridge 51 and introduces air to a space above the level 42 inside the ink container 11. Energy for downward flow and permeation of the ink 69 inside the ink container 11 through the end opening 37 and the long notch 38 of the drain conduit 33 sustains until ink level in the chamber 56 reaches the predetermined level 45. When ink enters the end opening 41 of the vent conduit 34, air inflow stops, the momentum of ink dropping is lost, and ink refill automatically terminates.

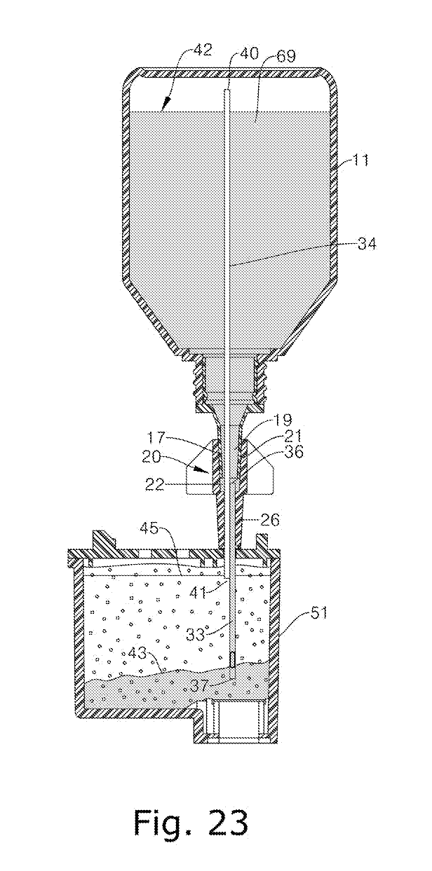

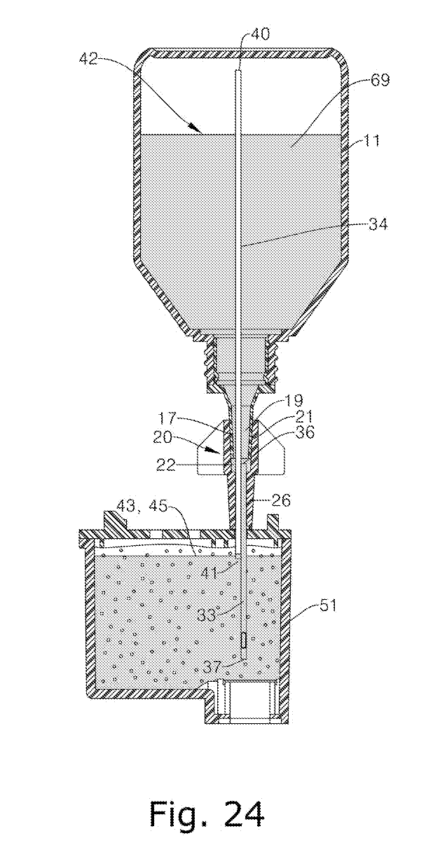

Pressure inside the two conduits 33 and 34 of the ink container 11 is automatically kept balanced after the ink refill stops. During inclination or detachment of the ink container 11 and the convective refill unit 20, remaining ink in the two conduits 33 and 34 will not drop when the convective refill unit 20 is removed from the refill hole 52 of the ink cartridge 51 if no pressure is imposed on the ink container 11. Thus convection refill for the ink cartridge 51 is complete. To be more specifically as demonstrated in FIG. 23, the ink inside the ink container 11 flows downward/outward through the drain conduit 33. The downward draining force of the ink is normally made by means of the air above the ink and the gravity of the ink itself (could be started or activated by means of slightly squeeze on the ink container 11). When the ink flows downward, inside of the drain conduit 33 is occupied by the ink, no space is left inside the drain conduit 33. Meanwhile, the air may simultaneously flows into the vent conduit 34 through the second 41, and then flows upward and passes through the first end 40 so as to enter the ink container 11. Hence, there is no ink left in the vent conduit 34, so that the vent conduit 34 is full of air. In this manner, air pressure and gravity of the ink may keep the ink inside the container 11 continuously flow downward/outward through the second end 37 of the drain conduit 33, and meanwhile keep the air enter the vent conduit 34 through the second end 41. Namely the convention, air pressure and the gravity of the ink play the predominate role to drive the flowing action in a smooth and continuous circumstance, and such that the ink level 43 will keep risen, to fill the ink cartridge 51. This automatically charging action is primary benefit of the present invention.

Please refer to FIG. 24, the ink will be automatically stopped flowing until the ink level 43 reaches the second end 41 of the vent conduit 34. The ink level 43 risen to stop level is predetermined level 45. The reason for automatically stop filling is that no air can be entered the vent conduit 34 because the second end 41 of the vent conduit 34 is blocked by the ink level 43. The air flowing into the ink container 11 is stopped means that the convection is hence impeded. In this manner, the air pressure inside the ink container 11 may keep balance against the ink gravity, to sustain the some ink liquid left inside the vent conduit 34. Since the balance is achieved, thus the convection and refill action is therefore stopped. This automatically charging stopped is also benefit of the present invention.

The above refill process depends on the vent conduit 34 of the convective refill unit 20, which extends to the bottom portion of the ink container 11 inserted upside-down on the refill hole 52 on the ink container 11. The first end 40 of the vent conduit 34 is above the level 42 inside the container. Once the bottle body of the ink container 11 is slightly pressed, the circulation system is activated and the ink in the ink container 11 drops and starts ink refill until ink level reaches the level 45 predetermined by the end opening 41 of the vent conduit 34 and stops ink refill. The start and stop of the circulation refill system completely depends on the deep insertion of the first end 40 of the vent conduit 34 in the ink container 11 and the setup of the level 45 by the insertion of the end opening 41 of the vent conduit 34 in the refill hole 52 of the ink cartridge 51.

Please refer to FIG. 13. The interior of the housing 93 of the ink cartridge 51 is divided into two chambers 58 and 59 with the partition 57. A smaller ink storage sponge 60 is installed only in the chamber 59. If the partition 57 is shifted rightward, space of the chamber 59 will get smaller and so will the installed ink storage sponge 60 and the amount of ink stored therein.

At this time, to refill the ink cartridge 51, the ink container 11 and the convective refill unit 20 are inserted upside-down in the refill hole 52 of the ink cartridge 51. The drain conduit 33 of the convective refill unit 20 is inserted deeply in a lower portion of the ink storage sponge 60 and the vent conduit 34 is disposed on the ink storage sponge 60. After pressing the ink container 11, the convective circulation system is activated when the drain conduit 33 initiates ink downward flow refill motion. The space of the chamber 59 of the ink cartridge 51 is automatically refilled with ink. Ink refill will stop when ink level reaches the level 45 predetermined by the vent conduit 34. The ink cartridge 51 will not be overfilled, or will ink overflow into a space of the chamber 58 with no sponge installed.

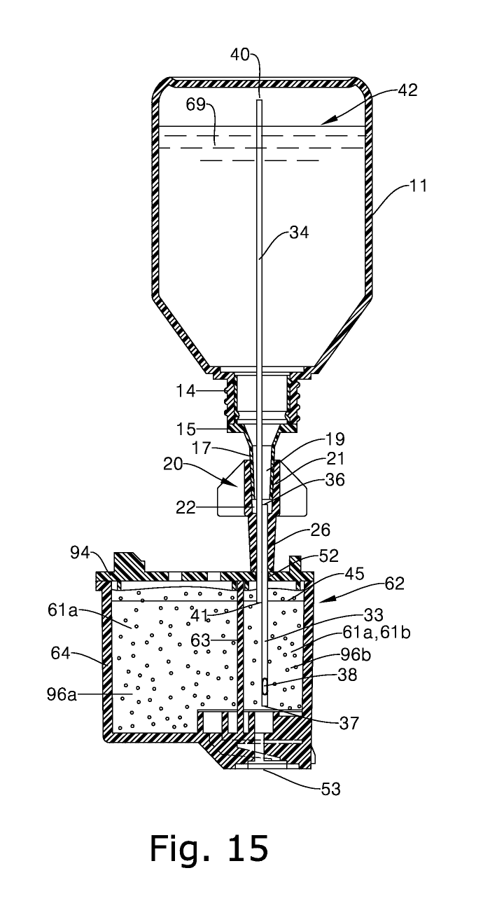

As shown in FIGS. 14 and 15, the housing 64 of the ink cartridge 62 is divided into several chambers 61a, 61b, (61c) with the partition 63 and ink storage sponges 96a, 96b, (96c) are installed inside the chambers respectively. A channel is disposed at a lower compartment of each chamber 61 to provide three or multiple colors to meet printing requirements of the inkjet head 53.

To refill the ink cartridge 62, fill the ink container 11 with inks of different colors and refill each chamber 61 of the ink cartridge 51 with ink one by one.

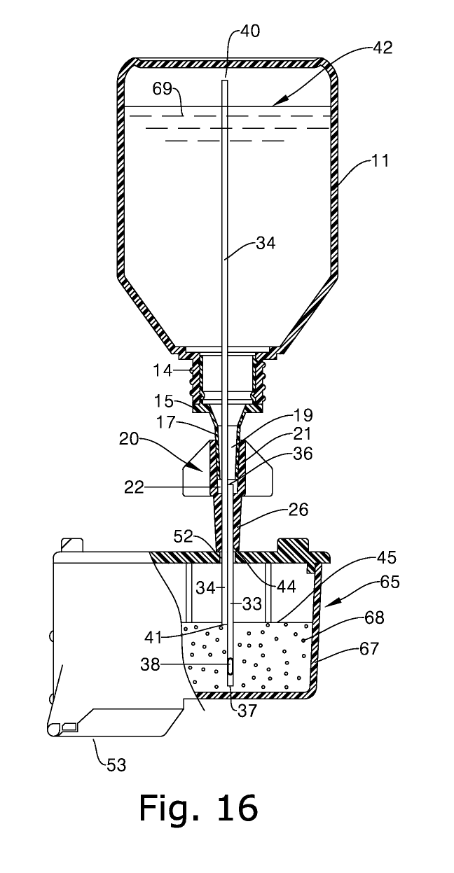

Ink cartridge manufacturers further provides an ink cartridge as shown in FIG. 16. An ink storage sponge 68 of a smaller height is installed inside the housing 67 of the ink cartridge 65 and is filled with a smaller amount of ink to differentiate prices of ink cartridge with different volumes. During refill of the ink cartridge 65, the length of the drain conduit 33 of the column body 26 of the convective refill unit 20 is the same as the previous one and the insertion length of the vent conduit 34 in the ink container 11 remains the same. However, the length of the vent conduit 34 inserted in the ink storage sponge 68 in the ink cartridge 65 should be changed according to the height of the ink storage sponge 68 of the ink cartridge 65. Therefore, the whole vent conduit 34 is longer and the end opening 41 of the vent conduit 34 is in contact with an upper portion of the ink storage sponge 68. During refill of the ink cartridge 65, the convective refill unit 20 is inserted in and connected to the ink container 11 and is inserted upside-down in the refill hole of the ink cartridge 65. The ring surface 44 at the outer end of the column body 26 is in contact with a plane of the ink cartridge 65 to provide steady insertion for the convective refill unit 20. The end opening 37 and the long notch 38 of the drain conduit 33 disposed on a front end of the convective refill unit 20 is deeply inserted in a bottom portion of the ink storage sponge 68. The end opening 41 of the vent conduit 34 is also inserted to the predetermined level 45 in an upper portion of the ink storage sponge 68. Once the drain conduit 33 initiates ink downward flow refill motion, the convective circulation system is activated. A space of the chamber of the ink cartridge 65 will automatically be refilled with ink to the level 45 predetermined by the end opening 41 of the vent conduit 34 and complete the refill of the ink cartridge.

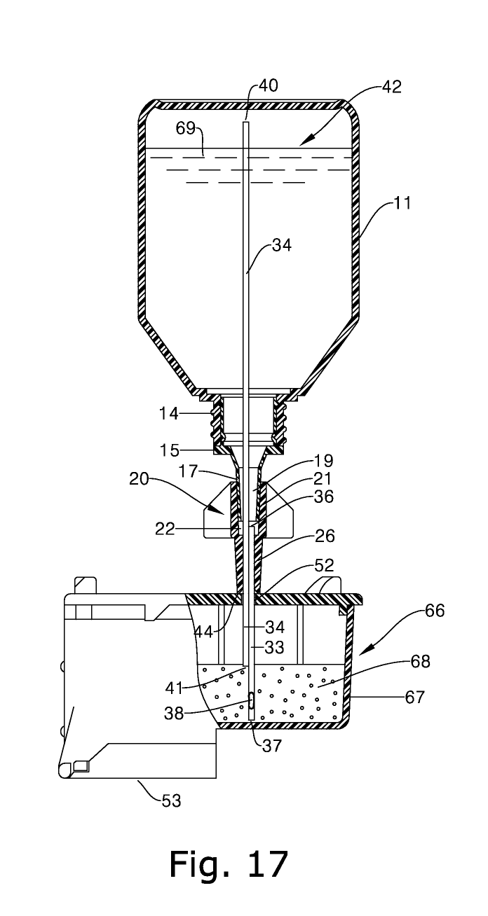

As shown in FIG. 17, the whole height of the ink cartridge 66 gets lower and the ink storage sponge 68 inside housing 67 gets even lower. The length of the drain conduit 33 disposed in the convective refill unit 20 is shorter because of the lower height of the ink cartridge 66. Correspondingly, the lengths of the drain conduit 33 and the vent conduit 34 outside the convective refill unit 20 inserted on the ink cartridge 66 should be adjusted according to the height of the ink cartridge 66. During refill of the ink cartridge 66, the convective refill unit 20 is inserted on the ink container 11 and is inserted upside-down in the refill hole of the ink cartridge 66. Due to the lower height of the ink cartridge 66, the ring surface 44 of an end of the column body 26 is flatly attached on an upper plane of the refill hole 52 of the ink cartridge and the end opening 37 of the drain conduit 33 is close to an inner plane of the housing. The end opening 41 of the vent conduit 34 disposed at the end of the convective refill unit 20 is inserted to the predetermined level 45 of the upper portion of the ink storage sponge 68. Once the drain conduit 33 initiates ink downward flow refill motion, the convective circulation system is activated, and a space of the chamber of the ink cartridge 66 will automatically be refilled with ink to the level 45 predetermined by the end opening 41 of the vent conduit 34, completing the ink refill.

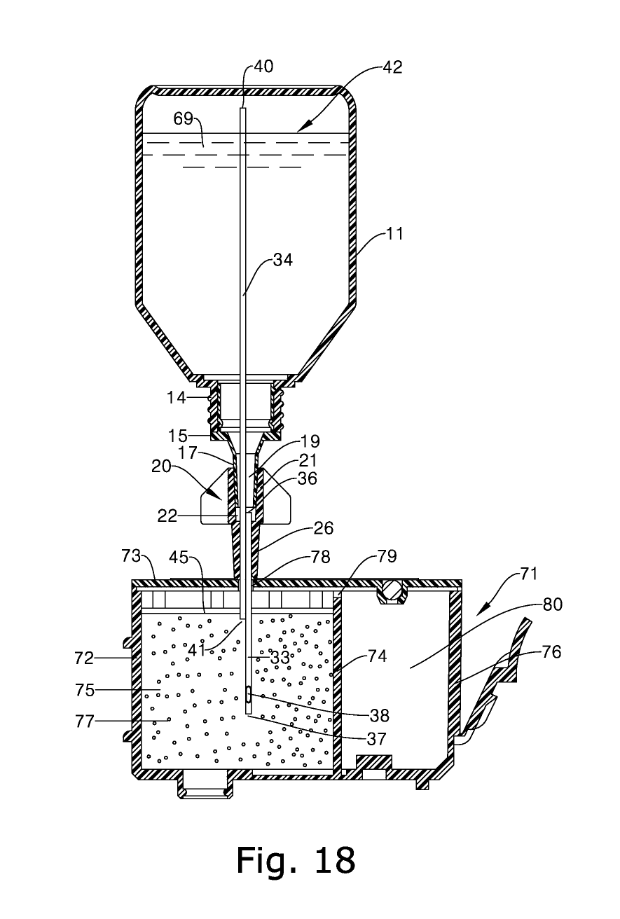

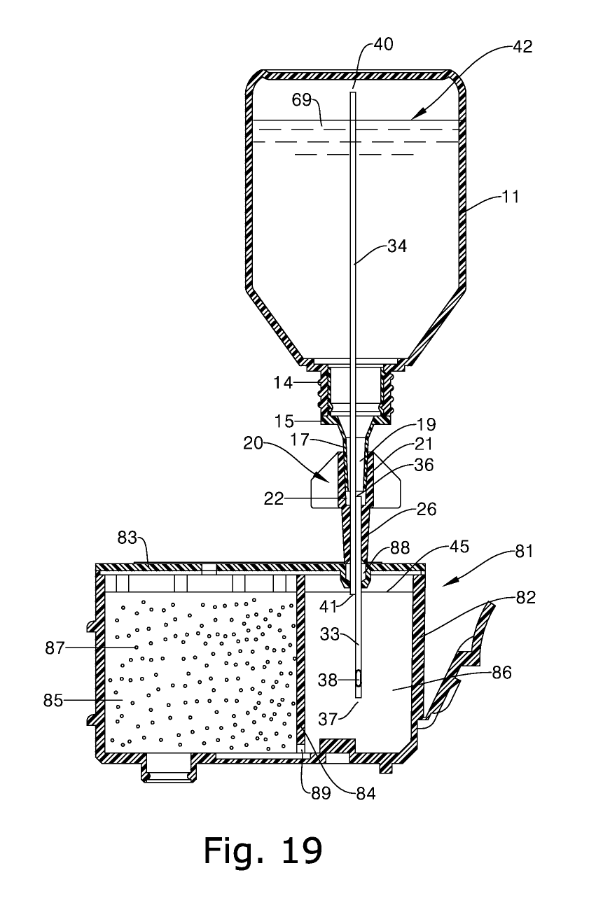

FIG. 18 shows an ink cartridge 71 holding a single-color ink. A housing 72 of an ink cartridge 71 is divided into two chambers 75 and 76 with a partition 74. An ink storage sponge 77 is installed in the chamber 75 of the housing 72. An upper cover 73 is disposed on and integrated with the housing 72. A gap 79 is disposed above the upper cover 73 and on the partition 74. A refill hole 78 and a sticker are disposed on the upper cover 73. The design of the gap 79 above the upper cover 73 and on the partition 74 originates from ink cartridge manufacturer's concern that a used ink cartridge 71 may be refilled with ink. During conventional refill of the ink cartridge 71, the ink storage sponge 77 retains ink that is hard to absorb and the refilled ink may overflow into the chamber 76 with no ink storage sponge installed.

During refill of the ink cartridge 71, the convective refill unit 20 is inserted on the ink container 11 and is inserted upside-down in the refill hole 78 of the ink cartridge 71. The end opening 37 of the drain conduit 33 does not reach the bottom of the chamber 75. However, this does not affect ink refill thanks to the method of convective refill and permeation. Similarly, the end opening 41 of the vent conduit 34 disposed at the end of the convective refill unit 20 is inserted to the predetermined level 45 in an upper portion of the ink storage sponge 77. Once the drain conduit 33 initiates ink downward flow refill motion, the convective circulation system is activated. A space of the chamber of the ink cartridge 71 will automatically be refilled with ink to the level 45 predetermined by the end opening 41 of the vent conduit 34 and complete the ink refill without the ink overflowing to the empty chamber 80 of the ink cartridge 71.

As shown in FIG. 19, a housing 82 of the ink cartridge 81 is divided into two chambers 85 and 86 with the partition 74. An ink storage sponge 87 is installed in the chamber 85 of the housing 82. An upper cover 83 is disposed on and integrated with the housing 82. A gap 89 of the housing 82 is disposed under the partition 84 and communicates both chambers 85 and 86. The upper cover 83 is integrated with the housing 82. The refill hole 78 and a sticker are disposed on the upper cover 83. Both chambers 85 and 86 can be filled with ink because of the gap 89 under the partition 84. Therefore, the amount of the stored ink is increased.

During refill of the ink cartridge 81, the convective refill unit 20 is inserted on the ink container 11 and is inserted upside-down in the refill hole 88 of the ink cartridge 81. The end opening 37 of the drain conduit 33 does not reach the bottom of the chamber 86 and the drain conduit 33 is suspended in midair in the chamber 86 of the ink cartridge 81. However, this does not affect ink refill thanks to the method of convective refill and permeation. The end opening 41 of the vent conduit 34 at the end of the convective refill unit 20 is inserted to the predetermined level 45 in a space of the chamber 86. Once the drain conduit 33 initiates ink downward flow refill motion, the dropping convection circulation is activated. Through the gap 89 under the partition 84, the ink dropping from the chamber 86 of the ink cartridge 81 will enter the ink storage sponge 87 in the chamber 85. The ink storage sponge 87 in the chamber 85 keeps absorbing ink until saturation. After the ink storage sponge 87 in the chamber 85 of the ink cartridge 81 stops absorbing ink, ink keeps dropping from the drain conduit 33 for refill of the chamber 86. Automatically refilled ink will reach the level 45 predetermined by the end opening 41 of the vent conduit 34 and complete the ink refill.

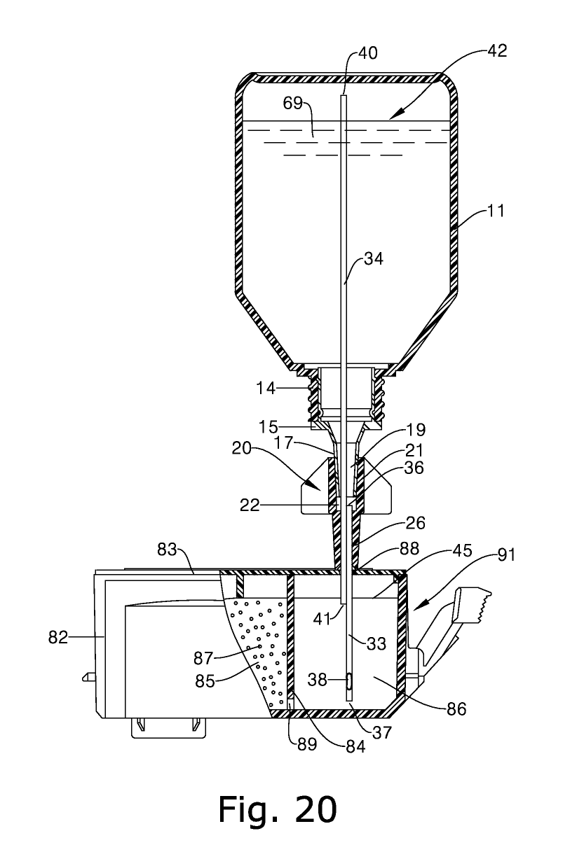

An ink cartridge 91 shown in FIG. 20 is similar to the ink cartridge 81 in FIG. 19, except for a lower height of the housing 82 of the ink cartridge 91 and a smaller ink storage volume. The principle for ink refill is the same as aforementioned and will not be described.

Summarily, the ink refilled convection device may smoothly flow the ink outward, without choked by the air pressure outside the conduit, hence no need to squeeze the ink container while the ink container is inversed and engaged with the ink cartridge (i.e. charging action for the cartridge). In this manner, convection and air pressure effect may be exploited to achieve automatically refill, until a predetermined ink level is reached. Then the charging action of the ink-refilled convection device will be automatically stopped through the convection blocked.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. An ink-refilling convection device for introducing ink into an ink cartridge comprising:
a convective refill unit, having a column body at upper portion of the convective refill unit with a recess disposed at top of the column body to communicate interior of the column body with exterior of the column body, a base body at lower portion of the convective refill unit, a first and a second cylindrical holes passing through the convective refill unit, a drain conduit disposed in the first cylindrical hole with an first end of the drain conduit going through an inner annulus of the column body toward a second end of the drain conduit which extends and exceeds the column body by a length, a vent conduit disposed in the second cylindrical hole with a second end of the vent conduit extending toward outer end of the column body which is located between the column body and the second end of the drain conduit; in which the first end of the vent conduit goes through the inner annulus of the column body, and a taper cylindrical hole is defined in the base body and communicated with the first and the second cylindrical holes;
an ink container having an inner cap disposed at opening of the ink container, the inner cap having a taper column detachably engaged with the taper cylindrical hole, and an opening hole passing through the inner cap;
wherein said convective refill unit is connected with the cap of the ink container, the convective refill unit of said vent conduit is passed through the opening hole with the first end of the vent conduit kept approaching to bottom of the ink container and the second end of the vent conduit extended to exterior of the column body through the recess.

2. The ink-refilled convection device of claim 1, wherein said drain conduit has a second end extended outward and gone beyond the second end of the vent conduit.

3. The ink-refilled convection device of claim 1, wherein said drain conduit and vent conduit are made of stainless steel tubes feature capillary tube structure.

4. The ink-refilled convection device of claim 1, wherein said convective refill unit is connected with the cap of the ink container, the first end of the vent conduit been inserted into the ink container, the first end of the vent conduit been above a level of ink if the ink container and the convective refill unit are turned upside-down to fill the ink.
